(19) United States
(12) Patent Application Publication
(10) Pub. No.: US 2008/0147601 A1
(43) Pub. Date: Jun. 19, 2008

(54) Method For Searching Data Elements on the Web Using a Conceptual Metadata and Contextual Metadata Search Engine

(75) Inventors: Frederic Chapus, Parkland, FL (US); Stephen N. Hord, Seattle, WA (US)

Correspondence Address: DARBY & DARBY P.C., P.O. BOX 770, Church Street Station, New York, NY, 10008-0770, US

(73) Assignee: UBMATRIX, INC., Kirkland, WA (US)

(21) Appl. No.: 11/575,625

(22) PCT Filed: Sep. 27, 2005
(86) PCT No.: PCT/US2005/034622

§ 371 Date: Jul. 27, 2007

Related U.S. Application Data
(60) Provisional application No. 60/612,871, filed on Sep. 27, 2004.

(51) Int. Cl. G06F 17/30

(52) U.S. Cl. 707/3; 707/E17.014

(57) ABSTRACT

An exemplary method for searching data includes receiving a search query comprising a conceptual metadatum parameter and contextual metadata parameters, locating a first set of instance documents containing a first contextual metadatum of the contextual metadata, filtering each instance documents in the first set to identify a data element in the instance document that indicates each parameter in the search query, based on definitions internal to the instance document and taxonomies or extensions associated with the instance document, and displaying the filtering results.

This application claims priority to U.S. Provisional Application No. 60/612,871 filed in the U.S. Patent and Trademark Office on 27 Sep. 2004. U.S. Provisional Application No. 60/612,871 is hereby incorporated by reference in its entirety.

### BACKGROUND INFORMATION

The search feature on web search engines is based on text and the presence of text elements in HTML/XML pages. In an example web search performed using the Google search engine and the text elements “Assets”, “Microsoft”, and “2002” provided a result of 655,000 HTML/XML pages that included those text elements. However, if a user desires to discern what Microsoft's assets were in the year 2002 based on this search result, the user must begin reviewing all 655,000 pages, one by one, until the desired information is found. In addition, once the information is found, the user must manually extract or transfer the desired information, by either re-keying the information or performing a copy and paste operation. Accordingly, a need exists for an automated, accurate search including the automatic or automated transfer of the data element into the user's system.

### SUMMARY

An exemplary method for searching data includes receiving a search query comprising a conceptual metadatum parameter and contextual metadata parameters, locating a first set of instance documents containing a first contextual metadatum of the contextual metadata, filtering each instance documents in the first set to identify a data element in the instance document that indicates each parameter in the search query, based on definitions internal to the instance document and taxonomies or extensions associated with the instance document, and displaying the filtering results.

Another exemplary method for searching data, includes receiving a search definition including an indication of contextual metadata representing an entity, searching for all XBRL instance documents that include the contextual metadata representing the entity, updating a repository or cache with XBRL instance documents located during the search and not already in the repository or cache, determining whether XBRL instance documents in the repository or cache and corresponding index, use a taxonomy appropriate for the conceptual metadata indexation, identifying XBRL instance documents in the repository or cache that include the entity identified in the searching, to form a first set of XBRL instance documents, filtering the first set of XBRL instance documents, based on the conceptual metadata element in the search definition, to form a second set of XBRL instance documents, displaying a list of XBRL instance documents satisfying the search definition, receiving a selection from the user, and displaying information satisfying the search definition, based on the user's selection.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements.

FIG. 1 shows an exemplary method.

FIG. 2 illustrates an exemplary search result.

FIG. 3 illustrates an exemplary system.

FIG. 4 illustrates an exemplary XBRL (eXtensible Business Reporting Language) Instance Document.

### DETAILED DESCRIPTION

The search feature on web search engines is based on text and the presence of text elements in HTML/XML pages. In an example web search performed using the Google search engine and the text elements “Assets”, “Microsoft”, and “2002” provided a result of 655,000 HTML/XML pages that included those text elements. A user who desires to discern what Microsoft's assets were in the year 2002 based on this search result, can begin reviewing all 655,000 pages, one by one, until the desired information is found. Then, the user can manually extract or transfer the desired information, by either re-keying the information or performing a copy and paste operation. Exemplary embodiments of the present invention relieve the user of this drudgery by providing an automated, accurate search including the automatic or automated transfer of the data element into the user's system, by searching on the Web using a combination of Conceptual Metadata and Contextual Metadata. An exemplary embodiment of the UBmatrix Conceptual and Contextual Metadata Search method includes a Conceptual Metadata and Contextual Metadata Search Engine and Processor (e.g., a UBmatrix COMSEP), which can be used with all XML-defined languages.

By way of further background information, the eXtensible Markup Language (XML) emerged from the World Wide Web Consortium (W3C) in 1998 as the key stone of a family of standardized languages. Each XML-defined standardized language is “vertically focused”.

The eXtensible Business Reporting Language is the XML-defined standard for analyzing, exchanging and reporting financial and non-financial information that has already been adopted world wide by major regulators, institutions and corporations.

For example, this service can be provided on a fee basis, whereby an authorized or known user or searcher (customer) logs onto a website including a search engine such as the UBMatrix COMSEP, and then enters a search definition for the search engine to work on and satisfy. An example search definition includes the following text elements:

Company: Microsoft

Data Concept: assets

Period: 2002-12-31

Currency: US$ (In Million: Checked)

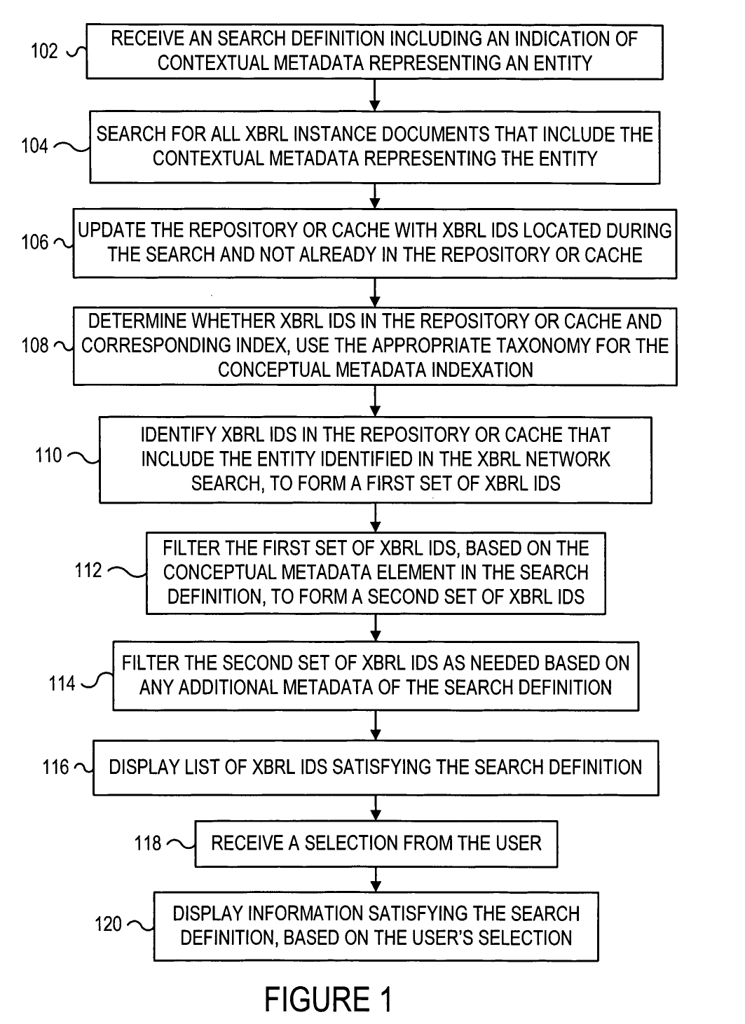

Note that “Assets” is an XBRL Conceptual Metadata Element, while the date “2002-12-31”, company name “Microsoft”, and currency parameters “US$, and in Million” are XBRL Contextual Metadata Elements. FIG. 1 illustrates an exemplary method for processing this search definition to obtain search results.

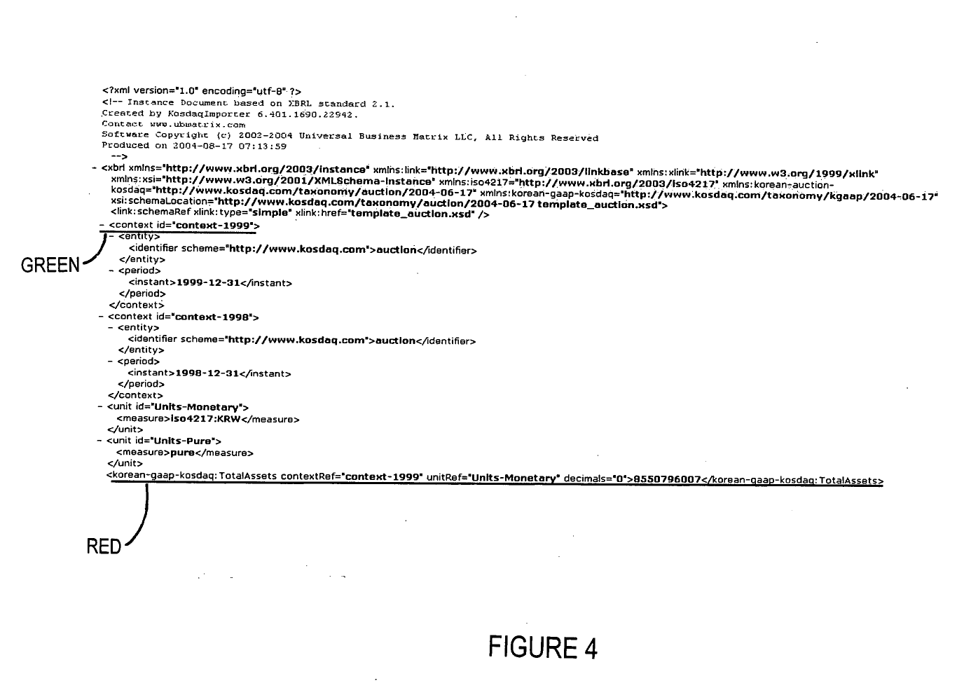

In accordance with an exemplary method shown for example in FIG. 1, a first block 102 includes receiving a search definition including an indication of Contextual Metadata representing an Entity. The search definition can be received, for example, from a user, for example in response to menus and/or queries to the user, via a graphical user interface, an aural interface, or any other interface or combination of interfaces. In an exemplary embodiment, search definitions can be pulled sequentially from a user-provided or predetermined list of searches to be performed. An Entity (e.g, an Entity Conceptual Metadata) can be either a physical person (ex: Mr. Smith) or any kind of structured entity such as a corporation (in FIG. 4: Microsoft), governmental or non-governmental organization, or even products or objects such as boats, cars, hotels, and so forth. In an exemplary embodiment, the search definition includes an XBRL concept or concept element, and can include additional contextual metadata. For example, a search definition can include contextual metadata “Microsoft” indicating and entity, contextual metadata “2004-12-31” indicating a time or time period, and an XBRL concept “Assets”, for example with an objective of finding a corresponding fact value such as “US$ 72,359,000,000”. In an exemplary embodiment, the search definition includes one concept metadatum. In another exemplary embodiment, the search definition includes multiple concept metadata.

From block 102, control proceeds to block 104, where a search is performed for all XBRL Instance Documents that include the contextual metadata representing the Entity. The search can be performed on a network, for example, the entire World Wide Web, the entire Internet, any subset of a network, any combination of networks or subsets of networks, and so forth. Any search engine can be used. In an exemplary embodiment, the search is directed to XBRL Instance Documents (IDs) not already in a repository or cache available to the search engine, for example a UBmatrix XBRL Business Reporting repository.

From block 104 control proceeds to block 106, where a repository or cache is updated with XBRL IDs located during the search and not already in the repository or cache. In an exemplary embodiment an index of the repository or cache, for example an XBRL Business Reporting repository Indexation, can includes names of providers of XBRL IDs, for example, Microsoft, Edgar, Forbes, and so forth.

From block 106, control proceeds to block 108 where a determination is made whether XBRL IDs in the repository or cache and corresponding index, use the appropriate Taxonomy for Conceptual Metadata Indexation. In an exemplary embodiment, if an XBRL ID does not use an appropriate taxonomy, it can be discarded, or flagged as unsuitable (e.g. for purposes of the present search), and/or transformed to use an appropriate taxonomy, using for example techniques described in U.S. Pat. No. 6,947,947. In an exemplary embodiment, the determination or verification can be limited to XBRL IDs that were newly added to the repository or cache during the update, in situations where other XBRL IDs in the repository or cache were previously verified as using an appropriate Taxonomy for conceptual metadata indexation. In an exemplary embodiment, other kinds of analysis or verification can additionally or alternatively be performed.

From block 108, control proceeds to block 110, where XBRL IDs in the repository or cache that include the Entity identified in the XBRL network search, are identified to form a first set of XBRL IDs. This can, for example, be performed by filtering or searching the repository or cache based on the contextual metadata identifying the Entity, for example to determine which of the XBRL IDs contain the contextual metadata identifying the Entity.

Control proceeds from block 110 to block 112, where the first set of XBRL IDs is filtered, based on the Conceptual Metadata element in the search definition, to form a second set of XBRL IDs. For example, the first set can be (further) filtered to select XBRL IDs of the first set that also include the conceptual metadata element of the search definition.

From block 112 control proceeds to block 114, where the second set of XBRL IDs is filtered as needed, based on any additional metadata of the search definition. For example, the search definition can contain additional contextual metadata, and thus the the second set can be sequentially filtered for each additional contextual metadatum or can be simultaneously filtered for all additional contextual metadata (for example, in accordance with various search techniques known in the art) to form next set(s) of XBRL IDs that contain all the terms of the search definition or otherwise satisfy all constraints of the search definition. E.g., the example described with respect to block 100 included a time period in addition to an entity and concept.

From block 114, control proceeds to block 116, where a list of XBRL IDs satisfying the search definition, is displayed to the user or otherwise output. The list can, for example, list the XBRL IDs, or the XBRL data providers of the XBRL IDs, or both. In an exemplary embodiment, the list includes XBRL IDs each having a (different) Data Element that satisfies the search definition (one Data Element satisfying the search definition per XBRL ID, each XBRL ID coming from a different Provider).

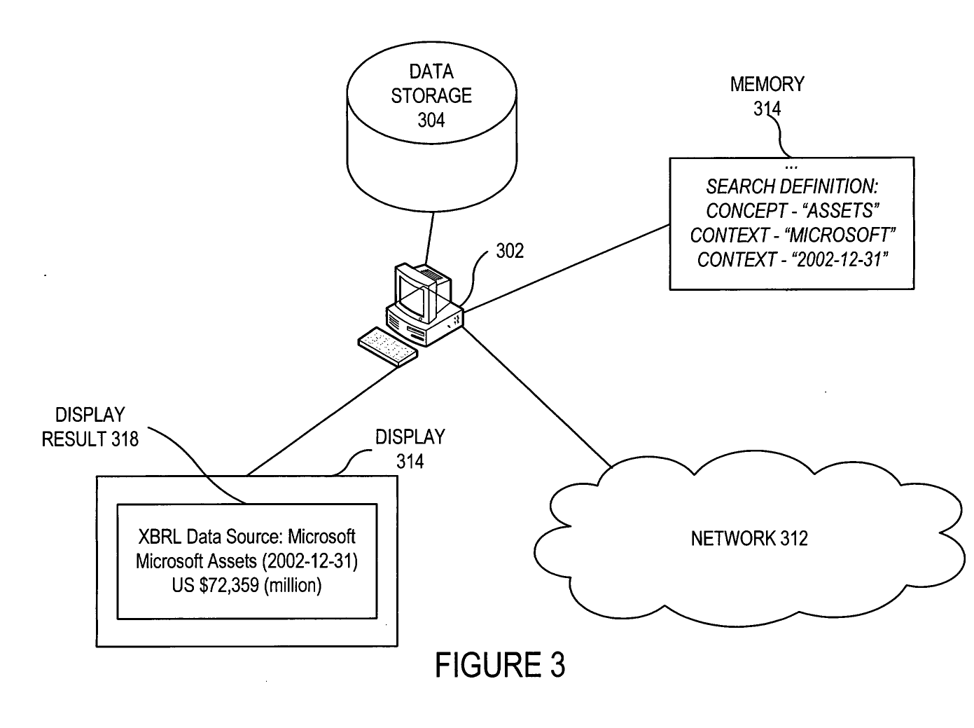

From block 116, control proceeds to block 118, where a selection of an XBRL ID and/or Provider is received from the user. A selection of a particular presentation format for the XBRL ID and/or the information satisfying the search definition can also be received from the user, and in a next block information is displayed in accordance with the selection(s) received from the user. Thus, the XBRL search can provide a single result, for example: Microsoft Assets @ 2004-12-31: US$ 72,359 Million, as shown for example in the display result 318 of FIG. 3.

FIG. 3 illustrates an exemplary system for performing the method shown in FIG. 1. In particular, FIG. 3 shows a computer or processor 302 connected to a data storage unit 304 (e.g. a hard drive or cluster of hard drives, one or more servers, or any local or remote data storage facility) and also a network 312, which can include the World Wide Web, the Internet, and so forth. Also shown are a memory 314 of the computer 302 with an example search definition, and a display 314 of the computer 302 showing an example result that satisfies the search definition.

The UBmatrix XBRL Search system and method can have multiple search options including single, multi, and cross-document search. In addition, UBmatrix XBRL Search can include an aggregated document search where one or more documents may be merged and/or processed before the search.

Users may have the option to specify a single XBRL Instance Document as the search target. They may store this instance on a local hard drive or on a larger server based system, and the instance may have one or more XBRL Contexts. In either scenario, the user pre-selects a specific document prior to beginning the search process. When searching multiple documents, the user may specify a set of individually selected documents, a directory (or any container for a collection of documents), or a repository service. Regardless of the storage mechanism, the user will provide similar search criteria such as entity name, period, concept name, and optionally a unit. The search results may contain one or more documents which contain the desired data.

Repository or Cache services may include simple server-based file storage systems accessible by any common computer to computer language such as SOAP, HTTP, or any other RMI (Remote Method Invocation) Technology. Repositories may also include management and aggregation services which attempt to discover and validate XBRL documents via the Web or made available thru a public or private registration/submittal process.

A Repository may act as a web crawler and attempt to discover publicly posted XBRL documents. Computer algorithms would be used to determine the relevance and authenticity of the documents. The Repository may also provide validation or business rule analyses as a value add service allowing users to not only search the original document but also search the results of the applied rules. The Repository may also allow users to upload or point to a privately stored Instance Document and authenticate that Instance Document via a password or any other authentication technology. The Repository could use a variety of storage technologies including the file system, a relational database, or a XML database. The storage technology would not impact the functionality of the repository.

Additional details regarding the UBMatrix XBRL Search Processor Methodology will now be discussed. Consider an example XBRL Search, related to the Korean Company “Auction”, where the search definition includes the company name “Auction”, an XBRL Concept Metadata “Total Assets”, a time “1999-12-31”, and a monetary currency “Korean Won”. As shown in the

XBRL Instance Document illustrated in FIG. 4, one Element (underlined in Red) corresponds to the XBRL Search Elements above. However, a) the Contexts “Auction” (Entity=Contextual Metadata) and “1999-12-31” (Period=Contextual Metadata) are not directly mentioned in the Element underlined in red: they are embedded in the “context id” named context-1999 underlined in green; b) the Context “Korean Won” (unit=Contextual Metadata) is not directly mentioned in the Element: Korean Won defined as unit id=“Units-Monetary” that is mentioned in the Element; and c) The Concept Assets is mentioned in the XBRL ID below as TotalAssets (Conceptual Metadata that is defined in the relevant taxonomy: korea-gaap-kosdaq).

Accordingly, in an exemplary embodiment the Search Processor evaluates the definition of “context id” to discern that it refers to entity and period contextual metadata having values “Auction” and “1999-12-31”, and also evaluates the “Units-Monetary” contextual metadata to discern that it refers to Korean Won. Thus the Search Processor processes or “reads” the Instance Document to determine that the data element <korean-gaap-kosdaq: TotalAssets contextRef:=“context-1999” unitRef=“Units-Monetary” decimals=“0”>8550796007</Korean-gaap-kosdaq: TotalAssets>satisfies the search query because it contains all of the search parameters (or logical references to the search parameters).

In Instance Documents produced using XML-defined language standards (e.g. XBRL), there are (and there will be) additional ways to create relationships between contextual metadata and their representation in Instance Document data elements using substitution, tuples, etc. The Search Processor will be able to read and evaluate all of these kinds of Instance Documents, including XBRL and non-XBRL instance documents. Some of the examples described herein refer to XBRL. However, the concepts and principles outlined herein can be applied to non-XBRL instance documents and elements, for example other XML-defined language standards.

In an exemplary embodiment, the UBmatrix XBRL Search Processor (using for example UBmatrix technology, or other technology) has the ability to read the XBRL Instance Documents, including context id information, and identify the data element(s) corresponding to the XBRL Search Concept, using the relevant taxonomy, extensions, and Contexts (e.g., contextual information, including for example definitions, in the instance document itself). For example, the UBmatrix XBRL Search Processor can automatically access the relevant taxonomy and extensions, etc. using web links, URLs, or other information included in the Instance Document that indicates where or how the taxonomy and extensions, etc. may be accessed. The UBmatrix XBRL SP will also index the XBRL Instance Documents. If there are several XBRL ID Data Elements that would include the search concept “Assets” (example: TotalAssets, GrossAssets, NetAssets, TotalAssets) the XBRL Search Processor would offer a corresponding list of options to the user. The user will check the appropriate option corresponding to his need. This selection could be integrated into the user's legacy system using SOAP (Simple Object Access Protocol).

After the XBRL Search Engine System has identified the appropriate Instance Documents, the UBmatrix Search Engine System identifies the Providers of such Instance Documents and submits a list of Providers, which is shown here as XBRL Data Sources.

The user can then choose the provider of his choice, and eventually will be prompted to select between multiple “contexts” or possibilities that include a “context” of his search. For example, if Assets were mentioned in the Search, the user may be invited to choose between: Current Assets, Non-Current Assets, Gross Assets, Net Assets and Total Assets; Same with the Context 2002-12-31: the user may be prompted to select between the result at the end of Q4 2002 or at the end of the calendar year 2002 and how he wants to get the information, which shows here two options Aggregated and Detailed.

The user can also be charged for the search either on a transaction fee basis, on a subscription fee basis, or on any pay-per-use or flat fee basis as proposed by the XBRL search service provider. The user can also be informed in real time about the cost of such XBRL search, and can have the option to export automatically the result into the legacy system of his choice. In an exemplary embodiment, the UBmatrix XBRL Search service can be integrated into the user's legacy system via a SOAP.

The UBmatrix XBRL Search Engine allows the user to select the following options: Data Source; detailed or aggregated information; and Automated Export, in which the user will have the possibility to program an automatic export of the XBRL Data into the legacy system or application of his choice such as Microsoft Excel, (using, for example, UBmatrix XBRL technologies).

Exemplary embodiments of the UBmatrix Search Engine include additional “Intelligent Functions”. For example, the Engine can include an automated currency converter, so that if the user searches for several financial data elements from multiple entities using different currencies for their business reporting, the UBmatrix Search Engine will offer to the users the possibility of converting these financial results into the currency of choice (using an automated multiple currency exchange system). The Engine can also perform or include automated language translation, measures systems, accounting standards, and so forth.

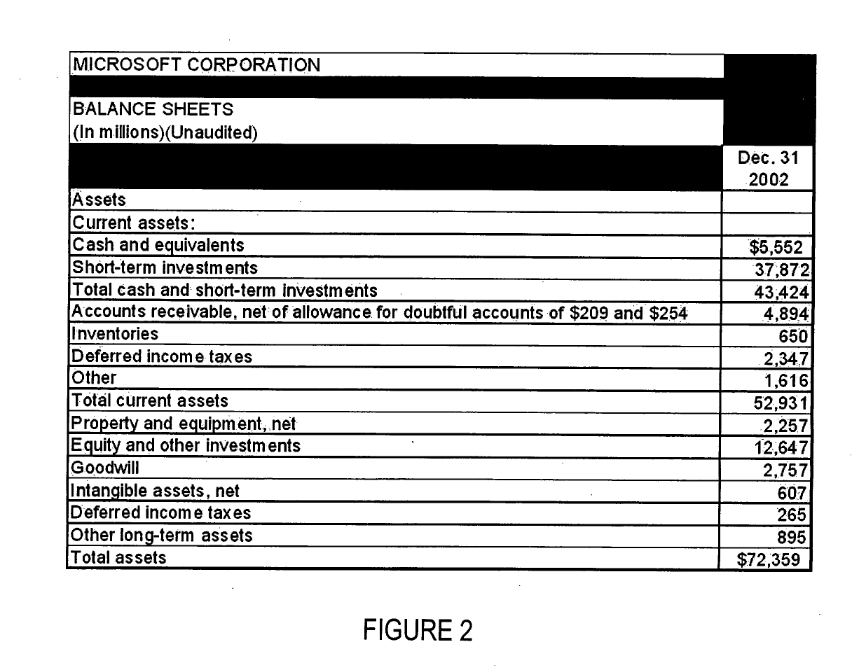

FIG. 2 illustrates an exemplary result of the UBmatrix XBRL Search options.

Exemplary embodiments further include additional functions and features, such as Web Page Links, where the UBmatrix XBRL Search Engine and Processor allow the user to: a) during XBRL Search processing or after the XBRL Search is completed, view the corresponding Web Page (if there is one); and b) If the User processes a search on the Web using a XML/XHTML Search Engine and reaches the stage where he is viewing a corresponding Web page that would be linked to an existing XBRL Instance Document, a link to the UBmatrix XBRL Search Engine and Processor will allow the user to complete his search using the UBmatrix XBRL Search Engine and Processor.

An exemplary search engine and processor can include statistical functions or capabilities, for example to analyze Business Report Data Elements belong to an “Entity” such as a corporation (in FIG. 4: Microsoft), a governmental or non-governmental organization. Statistics Data Elements can be related to sector of activity, or even products or objects (boats, cars, hotels, etc.). Statistics Data are aggregated data coming from multiple sources and frequently in a fragmented and non-standardized way: Statistics Bureaus, Associations, Government Agencies, etc. are used to provide Statistics using non-standardized formats and segmentations. An example of a Statistics Query is: “Number of Sailing Boats more than 30 feet long world wide?” Statistics bureaus from several countries can provide non-standardized and non-coherent data elements, for example: US Census can provide the number of sailing boats over 30 feet in the Great Lakes and on the East Coast; and a French Association of Sailing Boat Makers can provide the number of sailing boats over 10 meters in Europe, etc. When such statistics data are converted into XBRL and available on the Web, the UBmatrix XBRL Statistics Search Engine and Processor allows an automatic Statistics data collection using the following exemplary process: a) selection of the sector of activity (ex: pharmaceutical industry, tourism industry, etc.) or the products (ex: boats, cars, hotels, etc.); b) selection of “contexts” of the relevant sector of activity or product as needed for each specific Statistic Query; and c) additional Query information: ex: Length: 30 feet (see above the Statistics Query: Number of Sailing Boats more than 30 feet long world wide?).

The UBmatrix XBRL SSE (Statistical Search Engine) can also process a UBmatrix XBRL Search for Business Reporting data element, but through a UBmatrix XBRL Statistics Data Repository. The UBmatrix XBRL Statistics Data Repository uses data from the UBmatrix XBRL Business Reporting Repository to create statistics data by aggregating Business Reporting Data elements. The UBmatrix XBRL SSE also offers multiple options during the XBRL Search (including but not exclusively): selection of one or more statistics sources; aggregation of multiple results using the XBRL Search processor that will read and analyze all the relevant XBRL Instance Documents; and optional “extrapolation” from fragmented information will allow estimating, for instance, a world wide global number from a number available from one or several regions (the extrapolation can be based on any criteria as: population, gross production, etc.). The UBmatrix COMSEP can be adapted to all XML-defined languages.

As used herein, source data is a collection of items of data, which can for example be provided as input to a computer program in any kind of readable storage or transmission media, file, or stream, which include individual items. The individual items can include or comprise, for example, a recognizable single fact or business measurement. Examples of source data include: a spreadsheet or database table; a query resulting in data extracted from a database table; a comma-separated-variables file; an XML or HTML file or stream; a data stream output from a computer to one or more of a display screen, a memory, a hard drive, a CD ROM drive, a floppy disk drive a printer, or other device; and a table of data in a Microsoft Word document.

As used herein, metadata is data about data, for example that defines or characterizes data (e.g., by classifying items of source data). Metadata can include documentation or information describing characteristics, such as name; size, attributes, numeric or string constraints, conditions, optionality, and so forth. Metadata can include or indicate relationships with data or interrelationships among data, and metadata can be multidimensional. Classification metadata, for example, is often presented to computer programs in the form of a schema, data model, taxonomy, or dictionary. Contextual metadata may specify information about the data item being described, such as the reporting period, entity (business, government department, individual, etc.) that data item describes, and the reporting scenario; measurement metadata may specify the unit of measure of a data item (feet or meters, dollars or yen). Interrelationship metadata (which can be considered a form of contextual metadata) may organize or group data items for the same employee such as name, address, and department numbers together; footnote metadata may interrelate multiple data items with the same footnote reference, and can be considered a form of contextual metadata.

In an exemplary embodiment, the Search Engine looks for one or more Instance Document data elements in one or more Instance Documents (produced using XML-defined language standards, e.g., XBRL Instance Documents), wherein each located Instance Document data element contains all of the search parameters (conceptual and contextual metadata) and/or a direct or indirect references to such search parameters. See for example the “Auction” example described herein.

An exemplary method comprises: receiving a search query including (but not limited to) a conceptual metadatum and contextual metadata; locating a first set of instance document(s) containing one or more of the contextual metadata (e.g., a specified metadatum that will most accurately narrow the initial search); filtering the instance documents in the first set to identify a data element that contains each parameter in the search query or a reference thereto, based on one or more of definitions internal to an instance document, taxonomies or extensions associated with the instance documents; and displaying the filtering results.

Software packages, elements or modules for variously providing the functions described herein, can be implemented on a computer. These software processes running on the computer can additionally or alternatively be implemented in a distributed fashion external to the network using for example distributed computing resources, and/or can be implemented using resources of the network.

The methods, logics, techniques and pseudocode sequences described herein can be implemented in a variety of programming styles (for example Structured Programming, Object-Oriented Programming, and so forth) and in a variety of different programming languages (for example Java, C, C++, C#, Pascal, Ada, and so forth). In addition, those skilled in the art will appreciate that the elements and methods or processes described herein can be implemented using a microprocessor, computer, or any other computing device, and can be implemented in hardware and/or software, in a single physical location or in distributed fashion among various locations or host computing platforms. Agents can be implemented in hardware and/or software or computer program(s) at any desired or appropriate location. Those skilled in the art will also appreciate that software or computer program(s) can be stored on a machine-readable medium, wherein the software or computer program(s) includes instructions for causing a computing device such as a computer, computer system, microprocessor, or other computing device, to perform the methods or processes.

A machine readable medium can include software or a computer program or programs for causing a computing device to perform the methods and/or techniques described herein.

It will also be appreciated by those skilled in the art that the present invention can be embodied in other specific forms without departing from the spirit or essential characteristics thereof, and that the invention is not limited to the specific embodiments described herein. The presently disclosed embodiments are therefore considered in all respects to be illustrative and not restrictive. The scope of the invention is indicated by the appended claims rather than the foregoing description, and all changes that come within the meaning and range and equivalents thereof are intended to be embraced therein. The term “comprising” as used herein is open-ended and not exclusive.

1. A method for searching data, comprising:
receiving a search query comprising a conceptual metadatum parameter and contextual metadata parameters;
locating a first set of instance documents containing a first contextual metadatum of the contextual metadata;
filtering each instance documents in the first set to identify a data element in the instance document that indicates each parameter in the search query, based on definitions internal to the instance document and taxonomies or extensions associated with the instance document; and
displaying the filtering results.

2. The method of claim 1, wherein the instance documents are XBRL instance documents.

3. The method of claim 1, wherein the locating comprises searching the Internet for instance documents.

4. An exemplary method for searching data, comprising:
receiving a search definition including an indication of contextual metadata representing an entity;
searching for all XBRL instance documents that include the contextual metadata representing the entity;
updating a repository or cache with XBRL instance documents located during the search and not already in the repository or cache;
determining whether XBRL instance documents in the repository or cache and corresponding index, use a taxonomy appropriate for the conceptual metadata indexation;
identifying XBRL instance documents in the repository or cache that include the entity identified in the searching, to form a first set of XBRL instance documents;
filtering the first set of XBRL instance documents, based on the conceptual metadata element in the search definition, to form a second set of XBRL instance documents;
displaying a list of XBRL instance documents satisfying the search definition;
receiving a selection from the user; and
displaying information satisfying the search definition, based on the user's selection.

5. The method of claim 4, wherein the searching comprises searching the Internet for XBRL instance documents.

6. The method of claim 4, comprising:
filtering the second set of XBRL instance documents based on additional metadata of the search definition.

7. A machine readable medium comprising a computer program for causing a computer to perform:
receiving a search definition including an indication of contextual metadata representing an entity;
searching for all XBRL instance documents that include the contextual metadata representing the entity;
updating a repository or cache with XBRL instance documents located during the search and not already in the repository or cache;
determining whether XBRL instance documents in the repository or cache and corresponding index, use a taxonomy appropriate for the conceptual metadata indexation;
identifying XBRL instance documents in the repository or cache that include the entity identified in the searching, to form a first set of XBRL instance documents;
filtering the first set of XBRL instance documents, based on the conceptual metadata element in the search definition, to form a second set of XBRL instance documents;
displaying a list of XBRL instance documents satisfying the search definition;
receiving a selection from the user; and
displaying information satisfying the search definition, based on the user's selection.
